(19) United States
(12) Patent Application Publication
(10) Pub. No.: US 2012/0158534 A1
(43) Pub. Date: Jun. 21, 2012

(54) Auction Giftcard Redemption System

(76) Inventor: E. Buckley Barlow, South Jordan, UT (US)

(21) Appl. No.: 13/283,437

(22) Filed: Oct. 27, 2011

Related U.S. Application Data
(60) Provisional application No. 61/408,570, filed on Oct. 29, 2010.

(51) Int. Cl. G06Q 30/08

(52) U.S. Cl. 705/26.3

(57) ABSTRACT

An auction giftcard redemption system sends an electronic giftcard to a winning bidder according to preferences pre-determined by the bidder. The auction system may communicate current balances and give access to the giftcard on demand by a mobile device app or cell phone messaging services.

### THE FIELD OF THE INVENTION

The present invention relates to electronic giftcards. More specifically, the present invention relates to an auction giftcard redemption system.

### BACKGROUND

Gift cards are a booming industry. People are purchasing gift cards to allow friends and colleagues to choose their own gift and enjoy the shopping experience. Retailers like gift cards because they lock in customer money into the store and encourage customers to enter the store, which may include further purchases.

One of the popular distribution channels for giftcards are auctions. Bidders at auctions appear to like to get giftcards at less than face value, feeling like they get a good deal. However, with traditional giftcards, the fulfillment process may take some time. The auction house may have to activate the card and manually ship the giftcard to the winning bidder. Delays, lost shipments, stolen mail and other problems may further increase the costs of selling giftcards while reducing customer satisfaction.

The customer would like to have access to the won giftcard as soon as possible. A delay in getting the giftcard to the customer could lead to customer frustration and eventually leaving the auction site. On the other hand, a speedy delivery could mean that the customer would use the auction for last minute gifts, especially if the auction site is open 24 hours a day and 7 days a week.

Therefore, there is a need to provide auction winners with a giftcard as soon as possible after the win.

### SUMMARY OF THE INVENTION

It is an object of the present invention to provide an improved auction giftcard redemption system.

According to one aspect of the invention, after winning an auction for an electronic gift card, a customer may automatically receive an electronic giftcard through a pre-selected medium. In one preferred embodiment, the electronic giftcard is sent immediately upon the customer winning the auction.

In accordance with another aspect of the invention, the customer can change the pre-selected medium prior to delivery of the electronic gift card.

According to another aspect of the invention, the customer may reload the same giftcard by winning another auction. This may help the customer better use the value on the current giftcard and potentially encourage more purchasing for missing desired value.

According to another aspect of the invention, an electronic auction is provided which provides auctions of one or more electronic gift cards over computers or other processors on a local area network, a wide area computer network or a global computer network.

In accordance with another aspect of the invention, the electronic auction comprises a website on which a plurality of persons can participate in an auction and includes a means for entering a pre-selected medium for delivery of an electronic gift card upon a person winning the auction.

These and other aspects of the present invention are realized in an auction giftcard redemption system as shown and described in the following figures and related description.

### BRIEF DESCRIPTION OF THE DRAWINGS

Various embodiments of the present invention are shown and described in reference to the numbered drawings wherein:

FIG. 1 shows a system connection chart of an auction giftcard redemption system;

FIG. 2 shows a giftcard redemption chart;

FIG. 3 shows a flowchart of a giftcard purchase and delivery system;

FIG. 4 shows a flowchart of an auction giftcard redemption system;

FIG. 5 shows a flowchart of an auction giftcard redemption system with reloading;

FIG. 6 shows an auction delivery configuration screen;

FIG. 7 shows a giftcard selection screen;

FIG. 8 shows a giftcard redemption screen;

FIG. 9 shows a multimedia receipt screen;

FIG. 10 shows a text message receipt screen;

FIG. 11 shows an interactive text message query redemption screen;

FIG. 12 shows an interactive multi-media message query redemption screen;

FIG. 13 shows an interactive text message amount query result screen;

FIG. 14 shows asystem diagram of an auction system; and

FIG. 15 shows a system diagram of an auction giftcard redemption system;

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

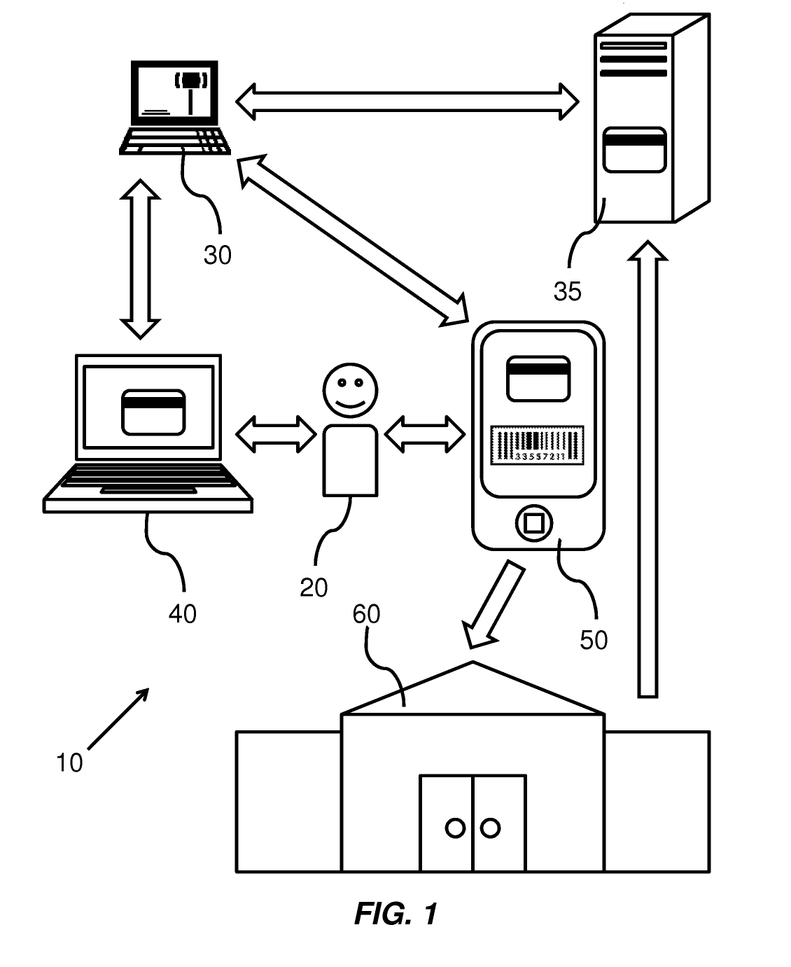

Turning now to FIG. 1, a system connection chart of an auction giftcard redemption system 10 is shown. A user 20 may access an electronic auction system 30, which may include one or more servers or other processors, from a computer 40 or mobile device 50. The user 20 may set up preferences with the auction system 30 which dictate preferred ways of receiving giftcards. The preferences may be stored in any of a variety of ways, such as being in a database or other storage medium associated with the individual user's account, or may be associated directly with a selected auction—such as a person designating how he or she would like to receive the subject matter of a winning bid upon completion of that auction.

The user 20 may then bid on electronic giftcards available from the auction system 30 by using an input device, such as the computer 40 or mobile device 30. Upon winning, a computer, software or other portion of the auction system 30 may access a giftcard server 35 to place the giftcard amount on a electronic giftcard, or the amount could have been preloaded on to an electronic gift card associated with the auction. Either way, the giftcard may then be automatically sent to the user or to a third person or entity according to the user's preference.

The giftcard may be electronically sent to a mobile device 50 or computer 40 for transfer to a mobile device 50. This can be accomplished in a variety of mechanisms, such as by email, text message, text file, binary file, database, XML code, HTML code or by alternate methods of transferring a file or other electronic data which will form the electronic giftcard. The information may also be encrypted.

The mobile device 50 or some other apparatus may then be used to access the giftcard to present to a store 60. The store or a computer or processor at the store may contact the giftcard server 35 and debit the amount spent from an account associated with the electronic giftcard. A computer or other processor at the store may also confirm that the electronic giftcard is valid prior to attempting to debit the amount associated from the electronic giftcard. The electronic giftcard server 35 may communicate with the auction system 30 such that the user's mobile device 50 and/or computer 40 access may be updated with the current amount left on the giftcard. This may include visually displaying the amount left on the giftcard so that the user is aware of the remaining balance.

The mobile device 50 may be a useful platform, as it may be unique to the user. In the case of a phone, the system may trust the phone number, as the phone number is unique to the user. In other embodiments, other data may be used to double check the validity of the data, including data signing, MAC address, ESN, MEID, and IMEI. The recipient of the electronic giftcard may also be required to provide a code or other information to verify safe receipt of the electronic giftcard and/or to make the electronic giftcard useable.

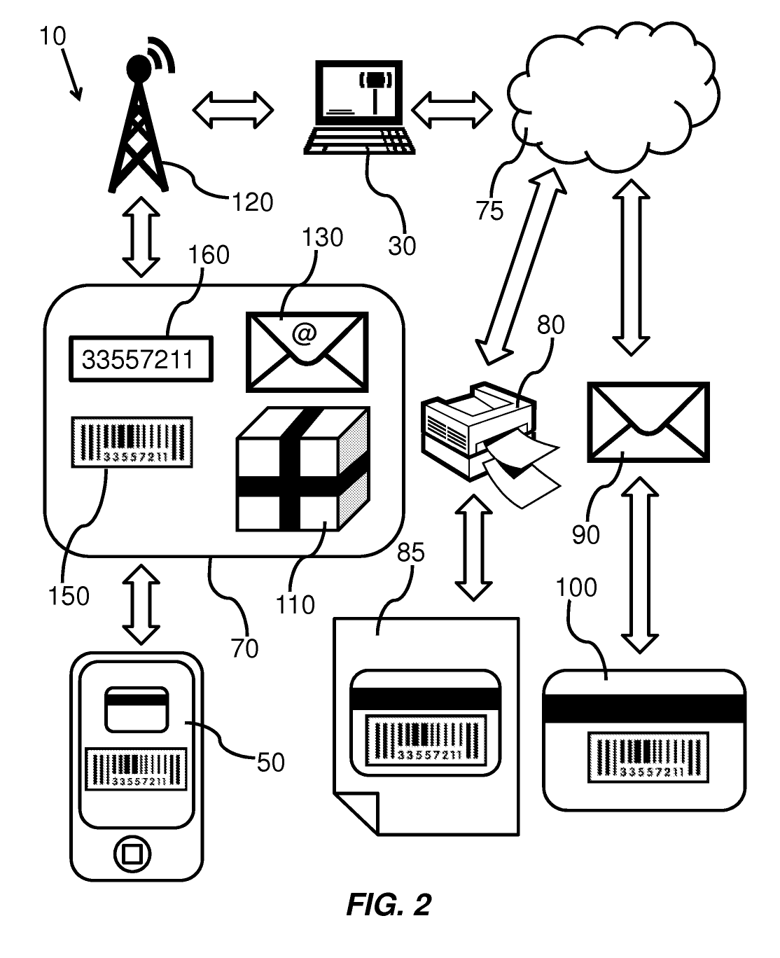

Turning now to FIG. 2, a giftcard redemption chart is shown. Once the auction has been won (and the giftcard server has authorized a giftcard if required) the gift card may be sent in accordance with a customer's preference. For example a person may desire that all of their electronic giftcards be sent to their smartphone. The electronic giftcard may be sent via giftcard information 70, using any of a variety of protocols, to a mobile device 50, a print at home service 80 for a paper printout 85 or via mail 90 with a tangible card 100. The information may be sent via the internet 75, wireless data network 120 or other communication.

In the case of a mobile device 50, the giftcard information 70 may be suited to the mobile device 50 capabilities. In the case of a smartphone, the auction system 30 may send a data package 110 (such as signed data, that may be encrypted) through a wireless data network 120 to an app on the mobile device 50. In the case of an email capable mobile device 50, an email 130 may be sent. Some users may prefer to receive a barcode picture 150 via a multimedia service such as MMS, that may be scanned at the retailer. For basic phones, a text message 160 with the giftcard number may be sent.

In the case of the package, MMS or email, a picture of a barcode may be shown on the mobile device 50. The barcode may be scanned at the retailer, as a normal giftcard is scanned. The transaction, thus may be made fairly instantaneous. Furthermore, the cost of delivery is significantly reduced over physical cards, as there is no postage, envelope or shipping processing. In fact, the system may be largely automated. The potential for lost, stolen or forgotten cards may also be reduced.

In the case of online stores or a basic phone, the system may provide a number which may be used to represent the giftcard. This number may be received by text message 160, inside the picture sent by MMS, within the email or available in the smartphone application.

By pre-selecting the delivery method of the giftcard, the user may quickly receive the giftcard while still enjoying the win at auction. This may further fuel the user's desire to bid in future auctions, as they have quickly received their winnings and are able to increase the pleasure associated with winning the auction by adding the pleasure of instantly using the gift card to purchase a desired item.

In one embodiment, the bidding software is integrated with the delivery application. Thus, the user can quickly receive the winning giftcard in electronic format in the same application from which the bid was won. Furthermore, the bidding application may show current auction items when started. This may encourage future bids, as the customer will see the auction items as they go to use their giftcards.

As the needs of the user change, the user may update their preferences. Thus, a user may select different delivery methods for future giftcard wins. In some cases, the user may need to have cards re-issued and/or reported as stolen. In one embodiment, the user may choose to have the giftcards re-issued because their phone was lost or stolen. If such is done, a previously sent electronic giftcard can be immediately deactivated to prevent it from being used by others.

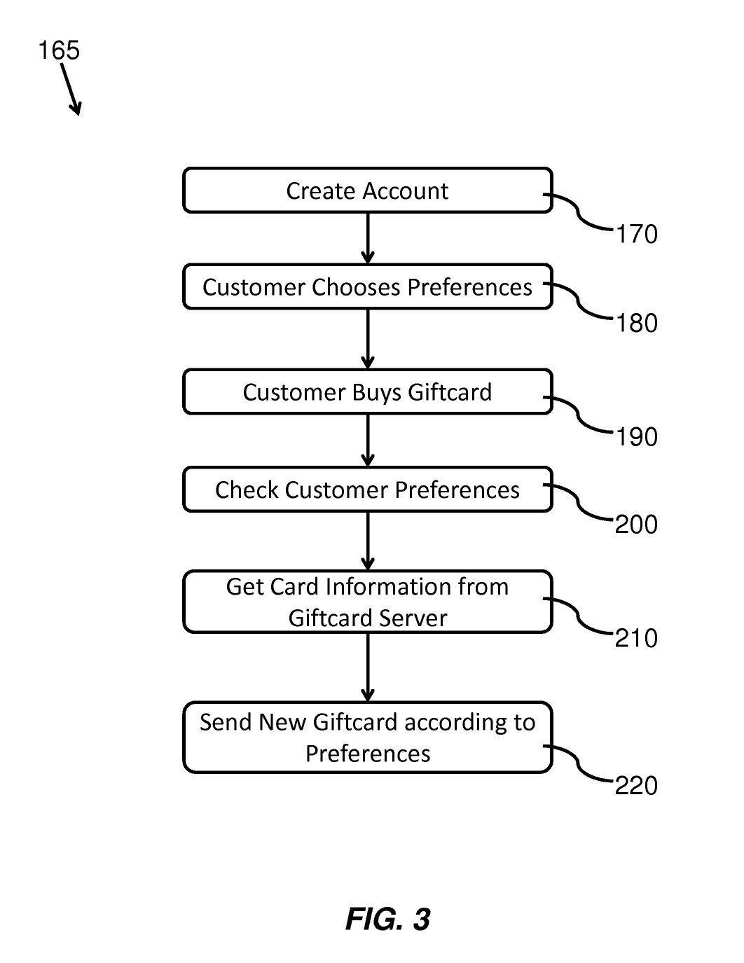

Turning now to FIG. 3, a flowchart of a giftcard purchase and delivery system 165 is shown. An account is created for a customer 170. The customer chooses delivery preferences of future giftcards 180. The customer may purchase a giftcard 190. After purchase, the system may determine the customer's preferences for delivery 200. The giftcard server may be contacted to obtain a correct balance on a giftcard 210. The electronic giftcard information may then be sent to the customer according to the customer preferences 220.

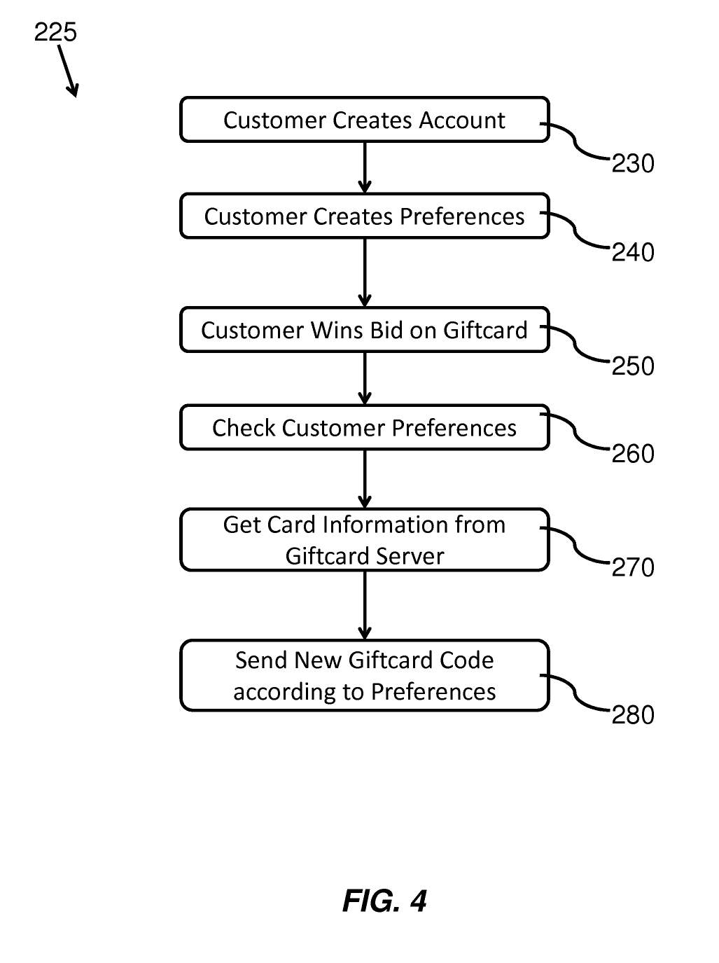

Turning now to FIG. 4, a flowchart of an auction giftcard redemption system 225 is shown. The customer may create an account 230. The customer then selects desired preferences, including giftcard delivery 240. The customer wins a giftcard in an auction 250. The system checks the customer preferences 260. The system contacts the giftcard server and receives information from the giftcard server 270 to create an electronic giftcard. The electronic giftcard data is sent to the customer according to the customer preferences 280.

It should be recognized that many of the processes steps may be rearranged or processed in parallel. The steps are shown in the order shown for clarity reasons. For example the check customer preferences step 260 may be done in parallel with the get card information from giftcard server 270 step or in reverse order.

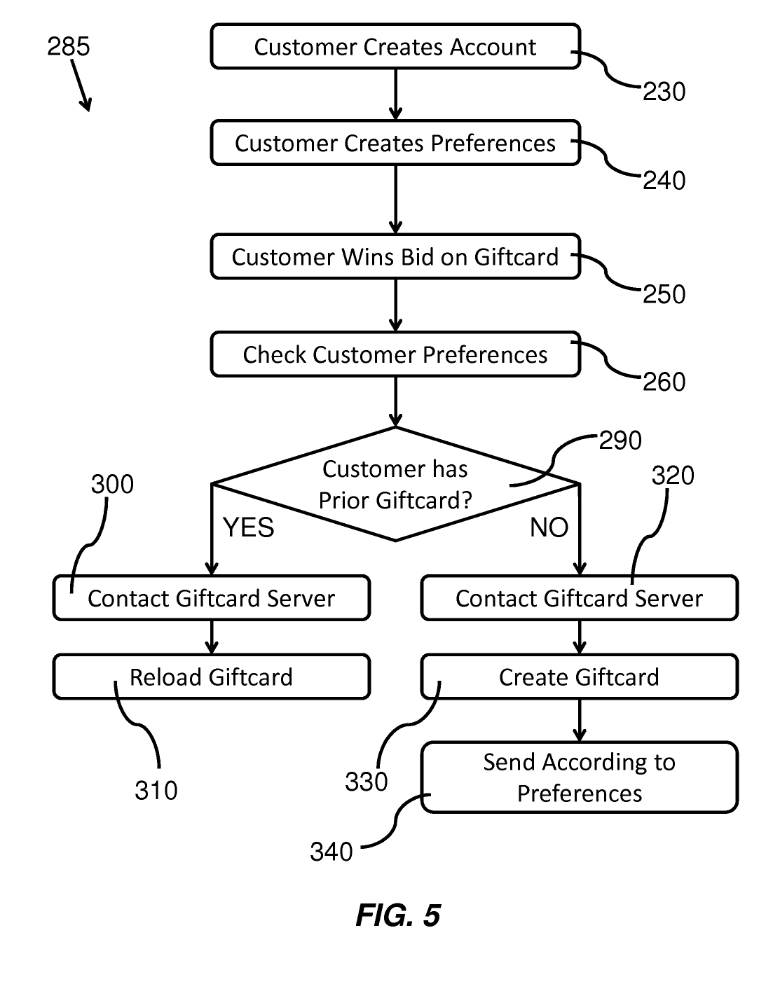

Turning now to FIG. 5, a flowchart of an auction giftcard redemption system 285 with reloading is shown. Steps from 230 to 260 are repeated from FIG. 4. However, if the customer has already received a giftcard to a store 290, the giftcard server may be contacted 300 and the prior giftcard reloaded 310. If not, then the giftcard server may be contacted 320, a new giftcard created 330 and the giftcard sent according to the customer preferences 340.

By reloading a giftcard form an auction, the customer may be able to use up more value in the giftcard, such as a giftcard that had a $5.00 balance may not buy much at a department store and may be awkward to present and have to pay for the difference in the purchase price. By reloading the card, instead of providing a new card, the customer may be encouraged to bid more to fill up the card to a useful level. Furthermore, it reduces clutter, as the user will not have to remember how many outstanding giftcards are present for each store. It also reduces the number of individual giftcard accounts that are required from the giftcard server.

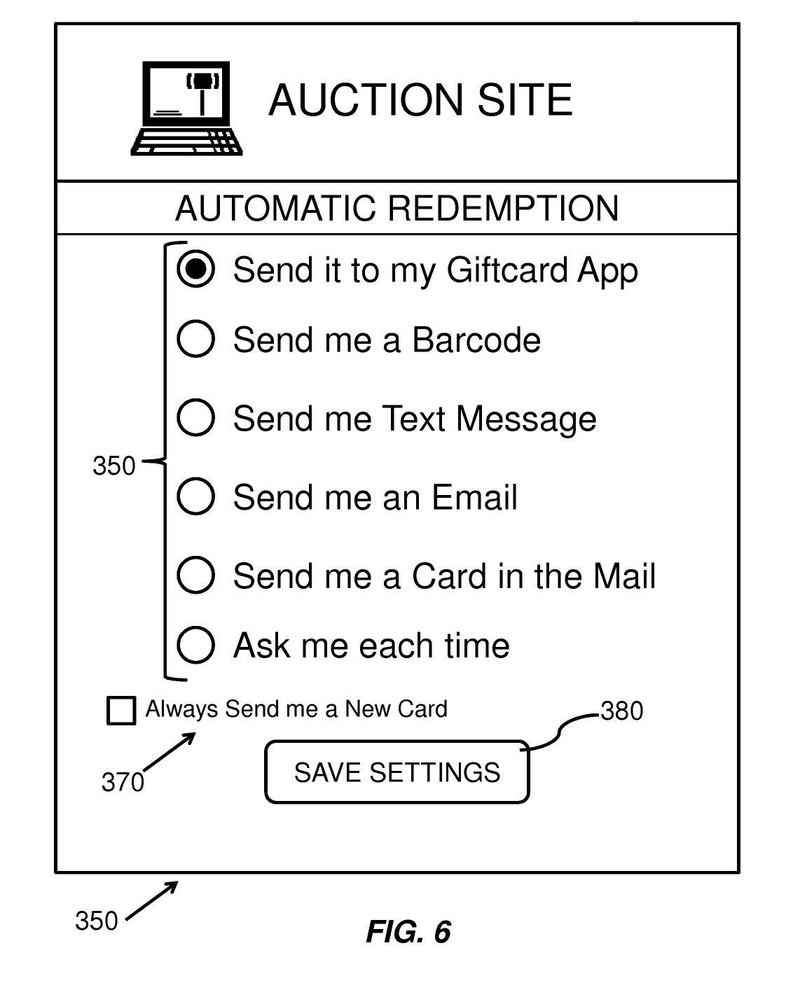

Turning now to FIGS. 6 to 13, exemplary interface screens are shown to help understand the invention. It should be recognized that individual mobile devices, computers and other processors may have their own native screens or displays and methods that effect the look and organization of the interface. However, many of the principles remain the same.

Turning now to FIG. 6, an auction delivery configuration screen 350 is shown. The Auction delivery site may be housed on any of a variety of different types of networks (involving various computers, processors, screens, etc), including the Internet.

The user may select a delivery preference 360 and/or a new card per win option. The delivery preference 360 may include delivery to an app, a barcode, a text message, an email, a physical card, or requiring the system to ask upon a winning bid. The user may also select from various options that may include an option to always create a new giftcard 370 rather than reloading previous ones. The settings may be automatically saved upon change or when a button 380 to save the settings is clicked.

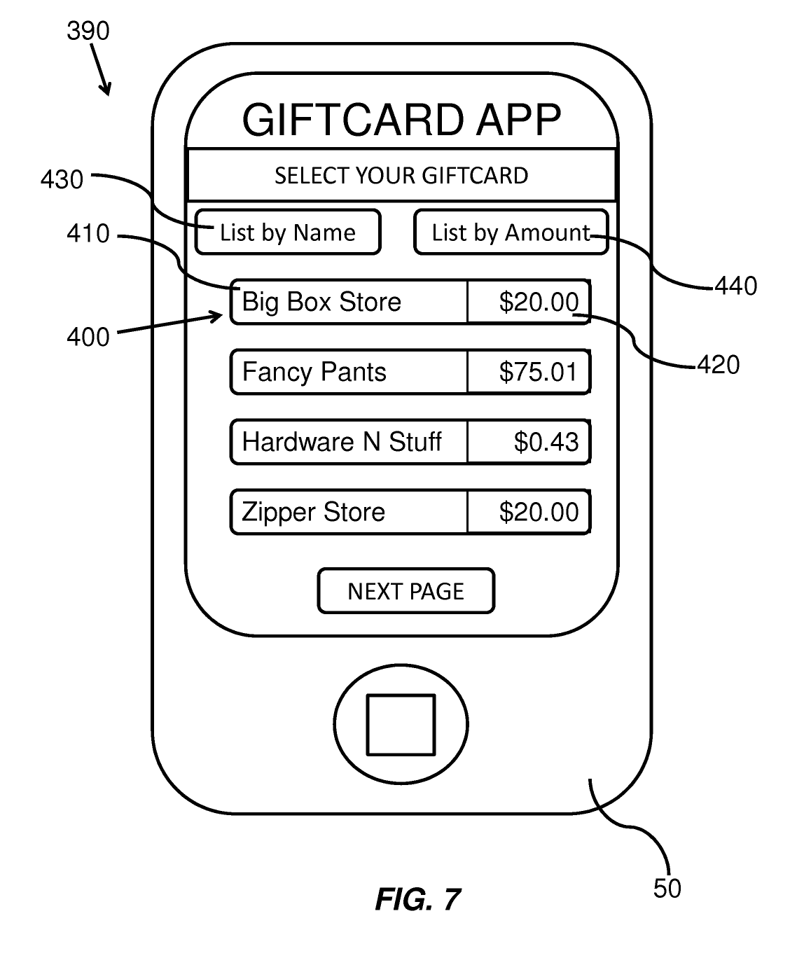

Should the user decide for an application delivery, FIG. 7 shows a giftcard selection screen 390 of an application. The application may list each giftcard 400 with the store name 410 and the amount remaining 420 on the giftcard. The application may also contain buttons to sort and/or search the giftcards 400, including organization by name 430 and organization by amount remaining 440.

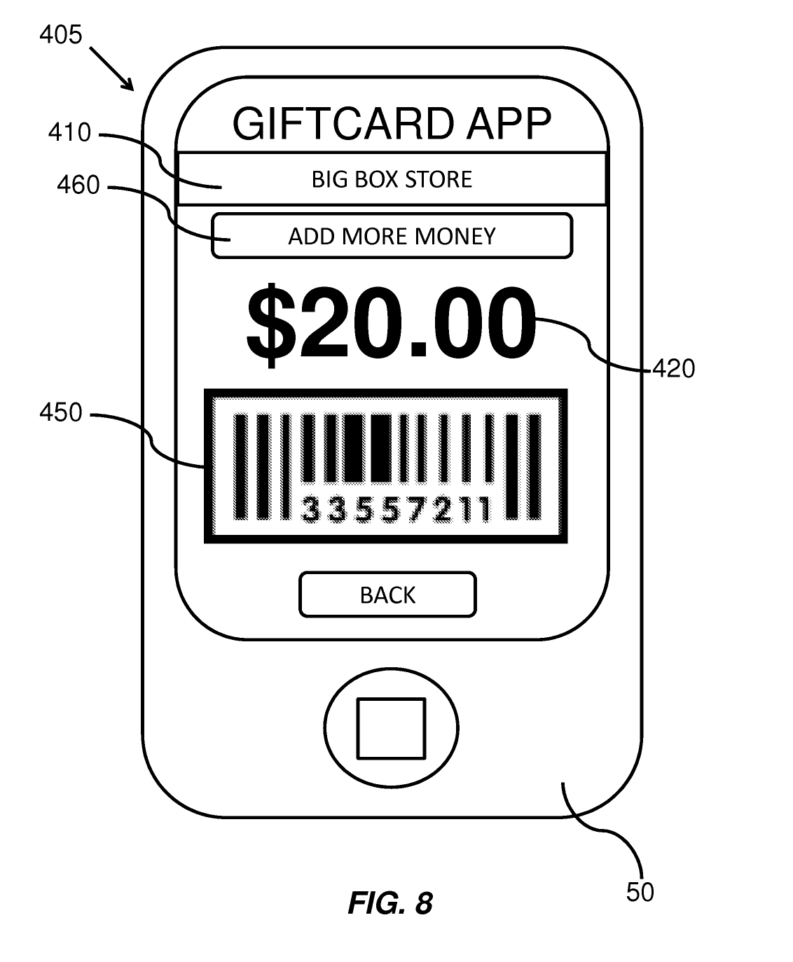

Once the user selects a giftcard, a giftcard redemption screen 405 may be shown as in FIG. 8. The name of the store 410 along with the amount remaining 420 and a scannable bar code 450. In one embodiment, the user may click on a button 460 to add money to the giftcard.

Using this screen, a user may present the mobile device 50 to a cashier for scanning as a giftcard payment method at a register. The scanner may read the barcode and apply the giftcard to the purchase.

In another embodiment, the mobile device may use a wireless protocol to provide payment at a terminal. For example, the mobile device may be configured to communicate with a gas pump wirelessly, such that the mobile device 50 need only be placed near the pump. In one embodiment, the mobile device may ask for confirmation of the purchase, such that another gas pump bill is not accidentally paid.

In some embodiments, further precautions are taken. In one embodiment, a password is required to be entered before the app will show payment information. In another embodiment, a one-use barcode or card number is used for each payment, such that a person may not steal the number to be used again. Any remaining dollar value would remain in the giftcard account.

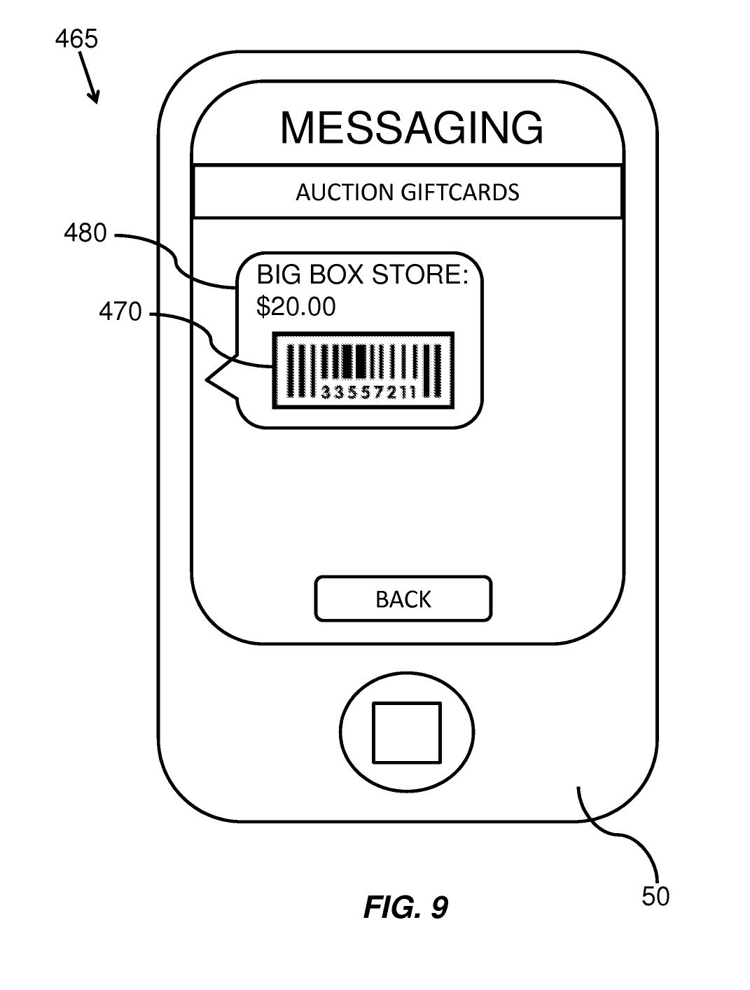

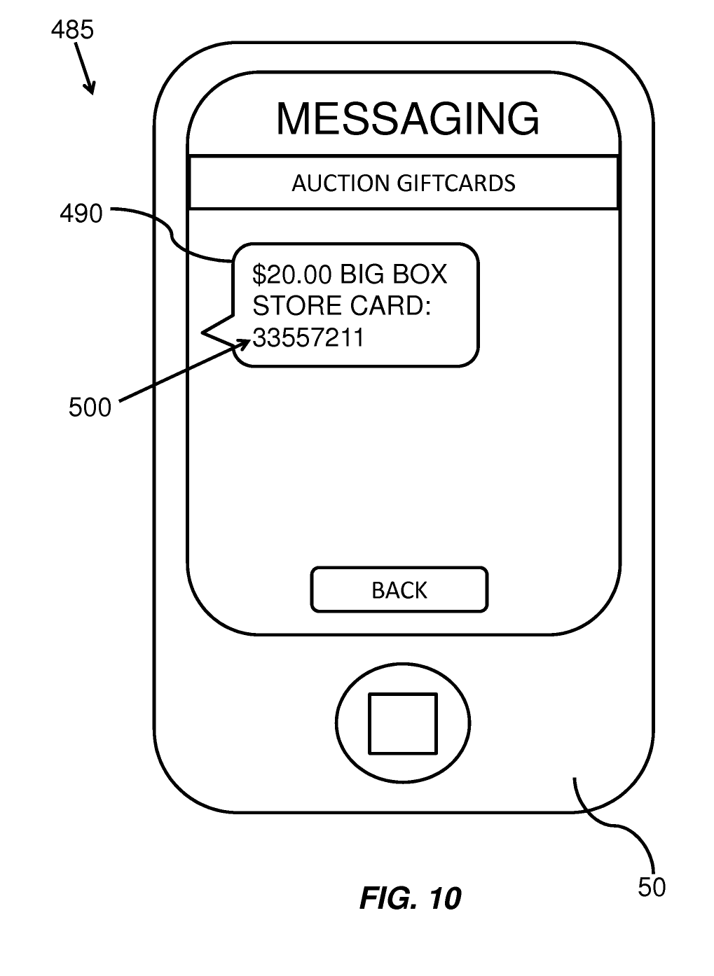

Turning now to FIGS. 9 and 10, messaging service deliveries are shown for multi-media (MMS) delivery 465 in FIG. 9 and text messaging (SMS) delivery 485 in FIG. 10. The auction system may also deliver through celluar messaging systems. Should the customer choose mult-media delivery of a barcode, the system may send the image of a barcode 470, along with a message about which store and how much is on the giftcard 480. If the user desires, they may request a status update of the amount on the giftcard sent to their mobile device with or without the barcode by logging into their account.

Similarly, if the customer chose to have a text-message delivery, the auction system may send a text message 490 that includes the card number 500. The card number may be input at a register or input into a giftcard payment field in an online retailer.

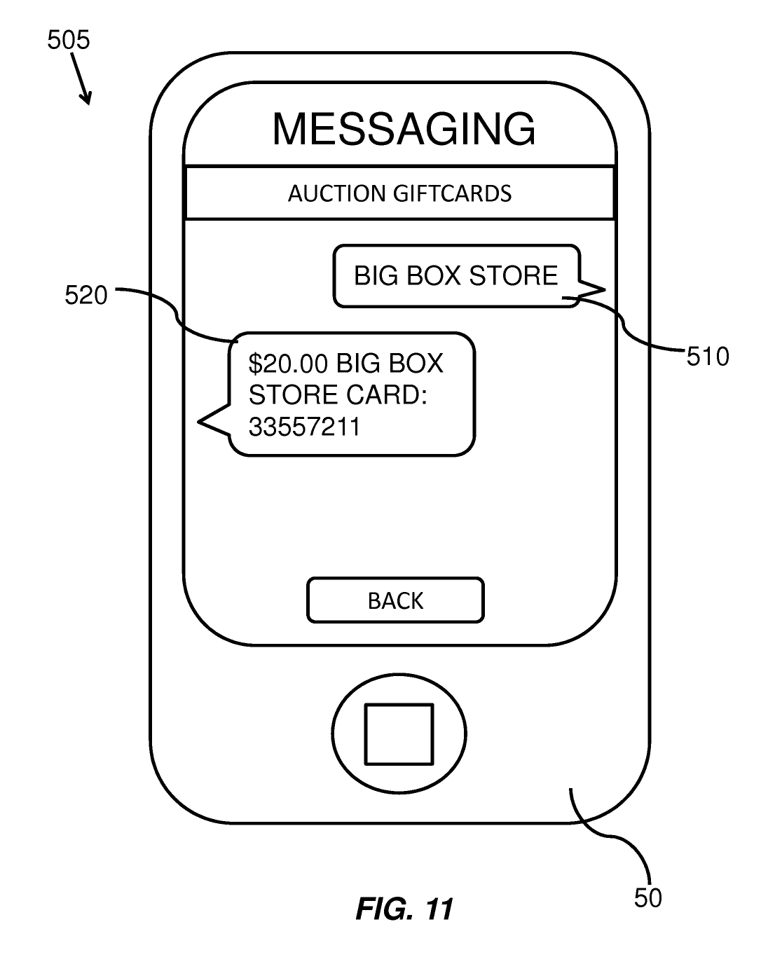

The auction system may also include a messaging system that responds to requests from an authorized phone as seen in FIGS. 11 to 13. As a user may choose to associate a mobile device with their account, the mobile device may be used to request status information or card information from the auction system. In the case of cell phones, the system can identify the incoming cell phone number and match that number with the associated account. Thus, the system may use a short code, email address or phone number to receive messages. The messages may then be decoded and an answer returned to the customer.

Turning now to FIG. 11, an interactive text message query redemption screen 505 is shown. A customer may send the auction system a message 510 with the name of a store. If the customer has a gift card related to that store, the system may respond with a message 520 displaying information about the giftcard, including a confirmation of the name of the store, the amount remaining on the giftcard and the giftcard redemption number.

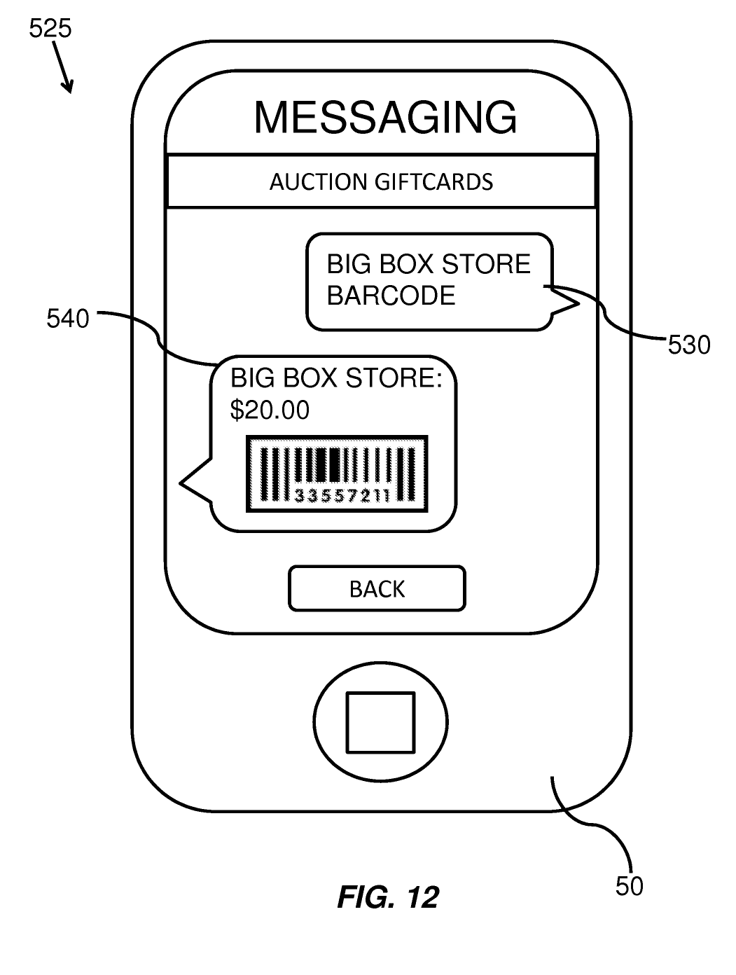

Turning now to FIG. 12 an interactive multi-media message query redemption screen 525 is shown. Should a customer preference be set or the message 550 contain a request for a MMS message, the auction system may return a message 540 that may include a barcode along with the other giftcard information discussed in FIG. 11.

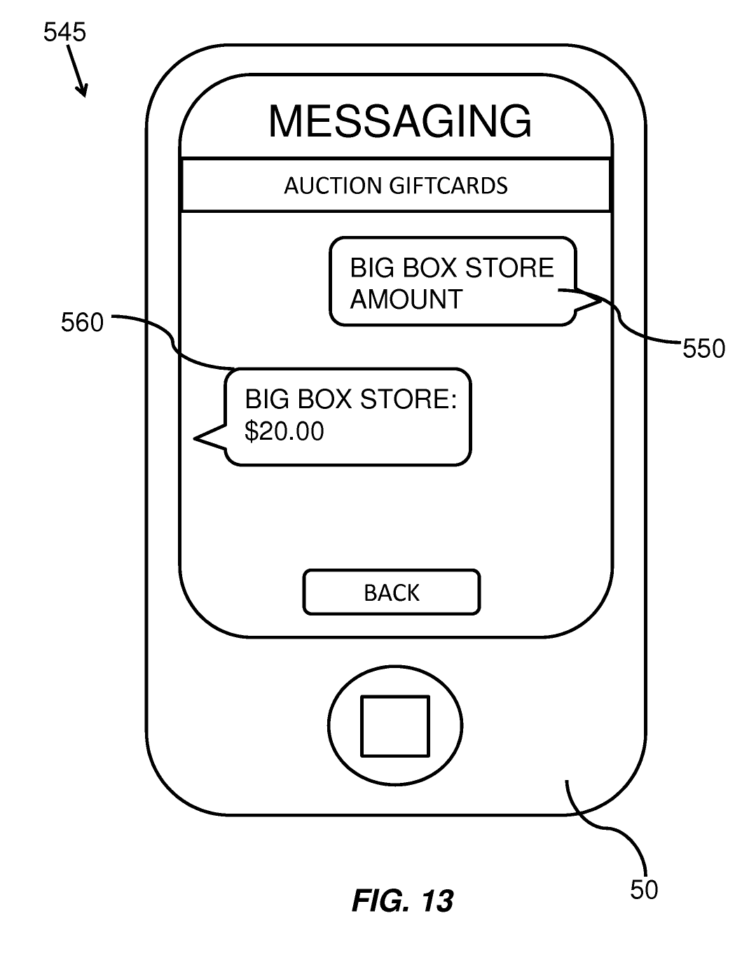

Turning now to FIG. 13, an interactive text message amount query result screen 545 is shown. In some cases, only specific information is desired. The customer may send a message 550 requesting only specific information. The auction system may read and respond to the request with only a confirmation and the information requested in a message 560. In this case, the customer only wanted to know the amount left on the BIG BOX STORE giftcard. The system confirmed the request was for the BIG BOX STORE and returned a balance of $20.00.

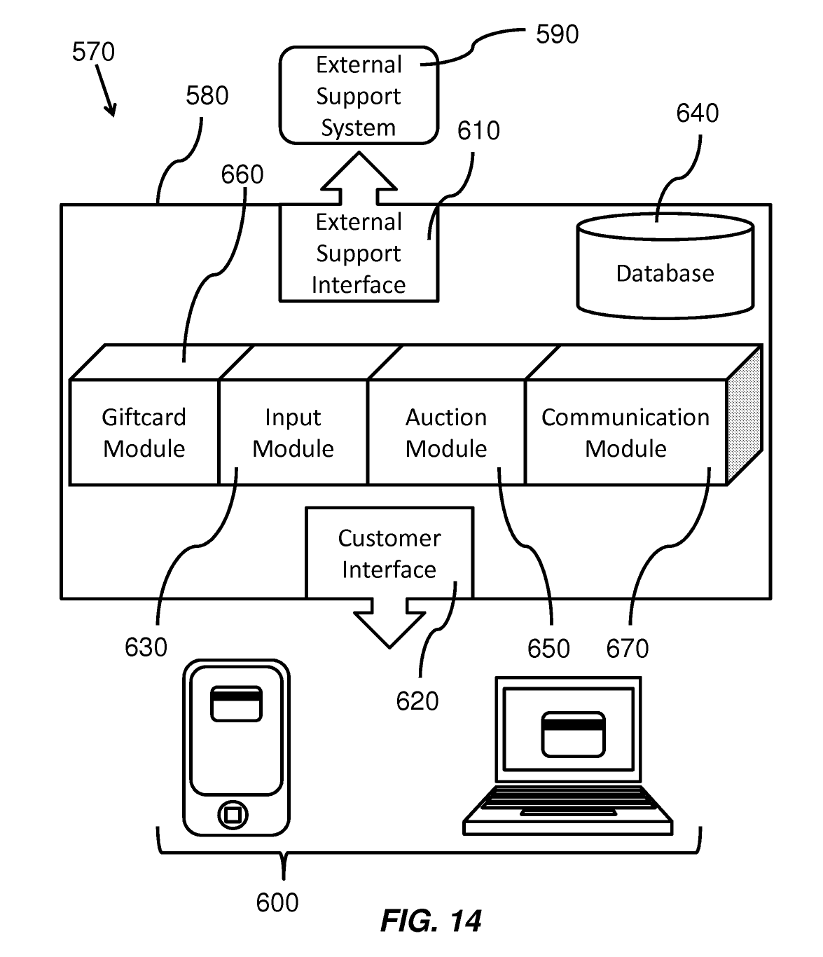

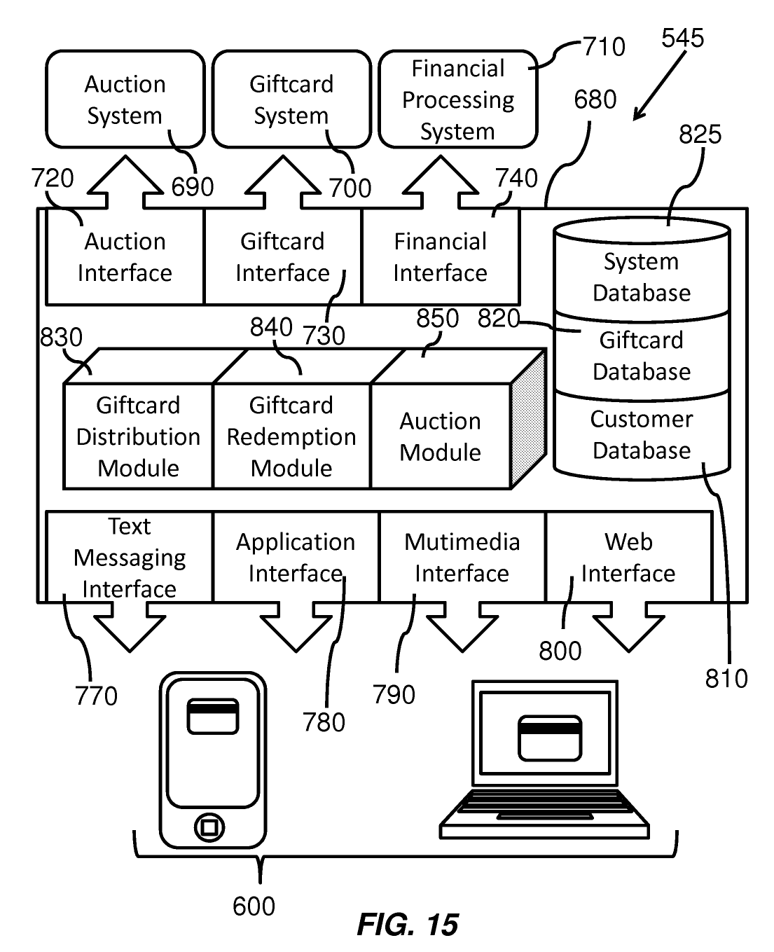

Turning now to FIGS. 14 and 15, a system diagram is shown of auction systems with an auction giftcard redemption ability. The systems may include interfaces to outside systems, modules for processing information and data storage, such as databases or file systems, for retaining information. These elements, modules, interfaces and systems, may exist across multiple computers, machines, processes, networks or other separation. In fact, the elements may be contained together in a single or multiple instructions or over separate code segments, among different programs, in separate code blocks or across several memory or storage devices.

Turning now to FIG. 14, asystem diagram of an auction system 570 is shown. The auction system 570 may contain an auction server system 580, external support systems 590 and client systems 600. External systems, such as credit card processing systems, may communicate with the auction server system 580 through interfaces. In the embodiment shown, external support systems 590 communicate with an external support interface 610. Client systems 600 may access a customer interface 620, such as a webpage, web service or other service or protocol.

The auction server system 580 may contain the storage and logic to facilitate an auction and giftcard delivery. An input module 630 may receive customer preferences to store in association with a customer account in a database 640. An auction module 650 may control the auction process and notify a giftcard module 660 on the even of a giftcard win. A communication module 670 may translate internal information into information that is usable across the interfaces. This may include receiving requests for information from the database and converting the information to follow a required protocol or data structure, such as XML.

Turning now to FIG. 15, a system diagram of an auction giftcard redemption system is shown. An auction giftcard redemption server system 680 may include several interfaces to support systems, internal programming and processing, storage and interfaces to client systems.

The support systems may include an auction system 690, giftcard system 700 and financial processing system 710. The auction system 690 may communicate new auction giftcard wins by customers along with a conduit to the customer accounts through an auction interface 720. The giftcard system 700 may communicate through a giftcard interface 730 to provide the ability to issue and reload giftcards. The financial processing system 710 may allow financial transactions through a financial interface 740, including accounting access and credit card processing. There may also be an administrative interface that allows administrative access to systems.

Client interfaces may include a text messaging interface 770, Application interface 780, multimedia interface 790 and web interface 800. Similar to what has been described above for the client services, each interface may manage a protocol and/or communication with a client system 600. The client system may receive the giftcard service through the customer's preference which may be stored in a customer database 810. The customers may further be associated with giftcards in the giftcard database 820. Other pertinent information may be stored in the system database 825, such as module configuration, authentication information for external systems, authentication information for client computers and other protocols, attributes or information.

Information may be processed through various modules including a giftcard distribution module 830, a giftcard redemption module 840 and an auction module 850. The giftcard distribution module 830 functionality may include managing the client giftcard requests including sending, responding to and distributing electronic giftcards to auction winners. The giftcard redemption module 840 functionality may include managing the financial aspects of the giftcard system including communication with the giftcard system and management of internal databases. The auction module 850 functionality may include responding to information from the auction interface and distributing new information to other modules.

There is thus disclosed an improved auction giftcard redemption system. It will be appreciated that numerous changes may be made to the present invention without departing from the scope of the claims.

What is claimed is:

1. An auction giftcard redemption system comprising:
an auction server, further comprising:
a database with one or more customer electronic giftcard delivery preferences;
a giftcard delivery system in communication with the database such that a customer with a winning giftcard bid on the auction server triggers the giftcard delivery system to send an electronic giftcard according to a customer electronic giftcard delivery preference associated with the customer with the winning giftcard bid; and
a giftcard server in communication with the auction server to return electronic giftcard information.

2. The system of claim 1, further comprising an electronic communication mechanism for forwarding an electronic giftcard to a person placing the winning giftcard bid.

3. A method of delivering an auctioned giftcard, the method comprising the steps of:
creating a customer account;
setting electronic delivery preferences for giftcard delivery for a plurality of customers;
completing an auction for a giftcard with a winning customer;
determining the winning customer's preferences from the electronic delivery preferences;
delivering the giftcard electronically according to the winning customer's preferences.

4. The method of claim 3 wherein the setting step further comprises the step of selecting delivery from the group of email, text messaging, multi-media messaging and application delivery.

5. An auction giftcard redemption system comprising:
a customer account;
a customer delivery preference stored in a database associated with the account;
one or more electronic giftcards associated with the account;
a mobile device associated with the account; and
an electronic giftcard delivery system that uses the delivery preference to send electronic giftcards associated with the account to the mobile device.

6. An apparatus for auctioning giftcards, the apparatus comprising:
a input module for receiving and storing information about a participant in an auction, the information including at least a desired delivery method for delivering the subject matter of an auction;
an auction module for conducting an auction; and
a communication module to forwarding the subject matter of the auction to a winner of the auction by the desired delivery method.

7. The apparatus of claim 6, further comprising a validation module in communication with the auction module for validating the subject matter of the auction prior to communication of the subject matter of the auction to a winning bidder.

8. The apparatus of claim 6, wherein the subject matter of the auction is an electronic giftcard.
